(19) United States
(12) Patent Application Publication
(10) Pub. No.: US 2016/0092413 A1
(43) Pub. Date: Mar. 31, 2016

(54) Method and System for Electronic Document Publication Preview

(71) Applicant: WORKIVA INC., Ames, IA (US)

(72) Inventors: Daniel Lloyd DeGeest, Ames, IA (US); Jeffrey Thieleke, Ames, IA (US)

(21) Appl. No.: 14/500,878

(22) Filed: Sep. 29, 2014

(51) Int. Cl. G06F 17/22; G06F 17/21; H04L 29/06

(52) U.S. Cl. CPC G06F 17/2247; H04L 67/42; G06F 17/227; G06F 17/212

(57) ABSTRACT

A method for previewing a publication of electronic documents is described. An electronic filing package that includes at least one electronic document is created. The electronic filing package is transmitted to a publication server for document validation processing of the at least one electronic document by the publication server based on one or more document validation rules. A processed package that has been processed by the publication server based on the one or more document validation rules is received from the publication server. A publication preview user interface is generated for the at least one electronic document based on the processed package.

### TECHNICAL FIELD

The present disclosure is related generally to electronic documents and, more particularly, to previewing a publication of electronic documents.

### BACKGROUND

XBRL is a standardized computer language by which businesses may efficiently and accurately communicate business data with each other and with regulating agencies. It is a markup language not too dissimilar from XML (eXtensible Markup Language) and HTML (Hyper Text Markup Language). HTML was designed to display general-purpose data in a standardized way, XML was designed to transport and store general-purpose data in a standardized way, and XBRL was designed to transport and store business data in a standardized way.

XBRL is bringing about a dramatic change in the way people think about exchanging business information. Financial disclosures are a prime example of an industry built around a paper based process that is being pushed into the technological age. This transition involves a paradigm shift from the pixel perfect world of building unstructured reports to a digital world where structured data is dominant.

In some business reporting systems and methods using XBRL, creating an XBRL representation of an electronic document is a laborious and error-prone task. While the SEC performs document validation processing on received electronic documents, any errors or warnings may not be readily discernible. In some instances, a user may submit an electronic document that is correct in its format, but with incorrect or old content.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is an example of a networking environment, including a data server, publication server, and client, in which various embodiments may be used;

FIG. 2 shows a possible implementation of the data server of FIG. 1, according to an embodiment;

FIG. 3 shows a possible implementation of the client of FIG. 1, according to an embodiment;

FIG. 4 is a flowchart that shows a procedure carried out by the data server of FIG. 1 for generating a publication preview user interface, according to an embodiment;

FIG. 5 a flowchart that shows a procedure carried out by the data server of FIG. 1 for processing a processed package received from the publication server, according to an embodiment;

FIG. 6 is a diagram of a publication preview user interface generated by the data server of FIG. 1, according to an embodiment.

### DETAILED DESCRIPTION

This disclosure is generally directed to methods and a computing device for previewing a publication of electronic documents. In various embodiments, a data server having a hardware processor creates an electronic filing package that includes at least one electronic document. The data server transmits the electronic filing package to a publication server for document validation processing of the at least one electronic document by the publication server based on one or more document validation rules. The data server receives, from the publication server, a processed package that has been processed by the publication server based on the one or more document validation rules. The data server generates a publication preview user interface for the at least one electronic document based on the processed package.

In some embodiments, the electronic filing package includes electronic documents that a business would prepare (e.g., Form 8-K or Form 10-Q) and transmit to the Securities and Exchange Commission (e.g., the publication server). The publication server processes the electronic filing package using various document validation rules, for example, to promote data consistency and integrity, uniform file characteristics, and display characteristics. While the document validation rules may be applied by another computing device (e.g., the data server or a client), discrepancies in the rules or their application may result in inconsistencies and thus the filing may appear differently or contain different information when actually processed and published by the Securities and Exchange Commission. Advantageously, the data server receives a processed package (e.g., a “return copy”) that has been processed by the publication server based on the one or more document validation rules but without an actual publication being performed. The data server then generates a publication preview user interface, such as an HTML interface, for the electronic documents based on the return copy. The publication preview user interface provides more accurate information about the filing because it uses the processed package that was processed by the SEC using up-to-date rules, instead of only a locally processed package. In some embodiments, the data server also compares the received return copy to the transmitted electronic filing package to determine whether any errors are present. The publication preview user interface simplifies the process of reviewing electronic documents for accuracy before filing with the SEC.

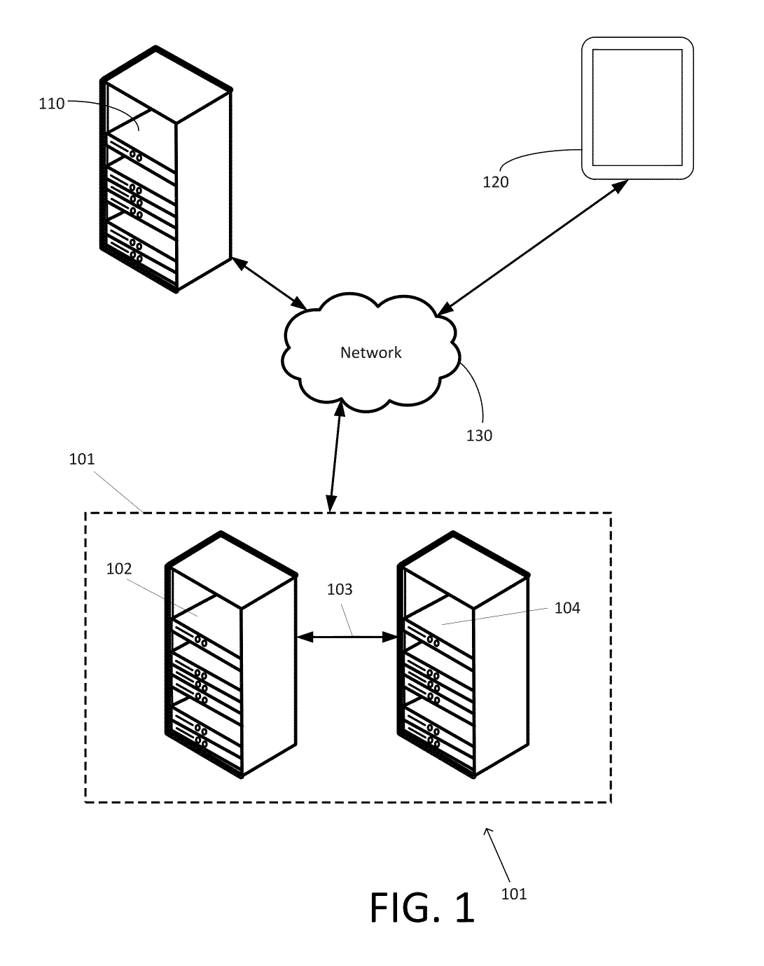

Turning to FIG. 1, in an embodiment, the various methods described herein are carried out by an electronic document publication preview system 100. In the embodiment illustrated in FIG. 1, the electronic document publication preview system 100 includes a first computing device, generally labeled 101, that is in communication with a second computing device 110 and third computing device 120 via one or more networks 130 (e.g., a local area network, a wide area network, a wired network, a wireless network, or the Internet). In one implementation, the first computing device 101 acts as a data server to the third computing device 120 and also communicates with the second computing device 110, which acts as a publication server. For ease of reference, the first computing device is referred to hereinafter as the “data server 101,” the second computing device 110 is referred to as the “publication server 110,” and the third computing device is referred to as the “client 120” of the data server 101. The first and third computing devices need not be in a server-client relationship, however. Although the data server 101 and publication server 110 are depicted in FIG. 1 as rack-mounted servers and the client 120 is depicted as a tablet computer, the data server 101, publication server 110, and client 120 may each be implemented as any type of computing device, including a desktop computer, notebook computer, or smartphone. Furthermore, there may be many other computing devices in communication with the data server 101.

In some embodiments, the data server 101 includes a front-end server 102 and a filing server 104 that communicate via a communication link 103 (e.g., via a communication bus, backplane, local area network, a wide area network, a wired network, a wireless network, the Internet, or other suitable interface). Various features or components may be provided in, or steps performed by, one or both of the front-end server 102 and the filing server 104. While the description herein generally refers to the data server 101, some features, components, or steps may be divided between the front-end server 102 and the filing server 104. In some embodiments, the front-end server 102 is a website server for interaction with the client 120, the filing server 104 securely interacts with the publication server 110, and the front-end server 102 interacts with the filing server 104 via the communication link 103. In this embodiment, increased processing efficiency or security can be provided by distributing processing tasks and reducing a number of communication paths to the publication server 110. In other embodiments, features may be provided by both the front-end server 102 and the filing server 104, for example, to provide redundancy.

The front-end server 102 in some embodiments processes electronic documents or files and provides a user interface for the client 120. The front-end server 102 packages the files into an electronic filing package and provides the electronic filing package to the filing server 104. The filing server 104 then communicates with the publication server 110, for example, to send the electronic filing package, receive a processed package (e.g., a “return copy” from an SEC publication server), and receive information related to the processed package. While in the present embodiment, the electronic filing package is sent directly to the publication server 110, in other embodiments or scenarios the electronic filing package is sent indirectly (e.g., via one or more intermediaries).

In various embodiments, a user may use a user interface, provided by the data server 101, on the client 120, such as a local computer or a remote computer over a network. Likewise, in various embodiments, the validation system may operate on a computer local to the user, local to the XBRL document preparation system 100, or remote from both over a network. In various embodiments, one or both of the XBRL document preparation system 100 or the external XBRL validation system 160 may be implemented using client-server architectures or as Software as a Service (SaaS) products. The XBRL document preparation system 100 may be controlled by and communicate via a user terminal or keyboard/mouse/monitor 210. The user terminal or keyboard/mouse/monitor 210 may be communicatively coupled with the XBRL document preparation system 100 via a direct electrical connection, for example USB, Thunderbolt, DisplayPort, VGA, HDMI, etc. Alternatively, the user terminal or keyboard/mouse/monitor 210 may be communicatively coupled with the XBRL document preparation system 100 via a network connection, for example a local area network using WiFi or Ethernet. Likewise, one or both of the XBRL document preparation system 100 and the external XBRL validation system 160 may be communicatively coupled with a data store 220. The data store 220 may include a hard disk drive and/or solid state drive communicatively coupled with both the XBRL document preparation system 100 and the third-party XBRL validation system 160. The data store 220 may be a network-attached storage system, a network server, or other data storage device capable of communicating with both the XBRL document preparation system 100 and external XBRL validation system 160 as known in the art.

The publication server 110 in some embodiments is a server operated by the Securities and Exchange Commission as part of the electronic data gathering, analysis, and retrieval (EDGAR) system. The EDGAR system performs automated collection, validation, indexing, acceptance, and forwarding of submissions by companies and others who are required by law to file forms with the Securities and Exchange Commission. The publication server 110 performs document validation processing of electronic documents based on one or more document validation rules. The document validation rules include rules that establish guidelines for content, format, and other publication criteria.

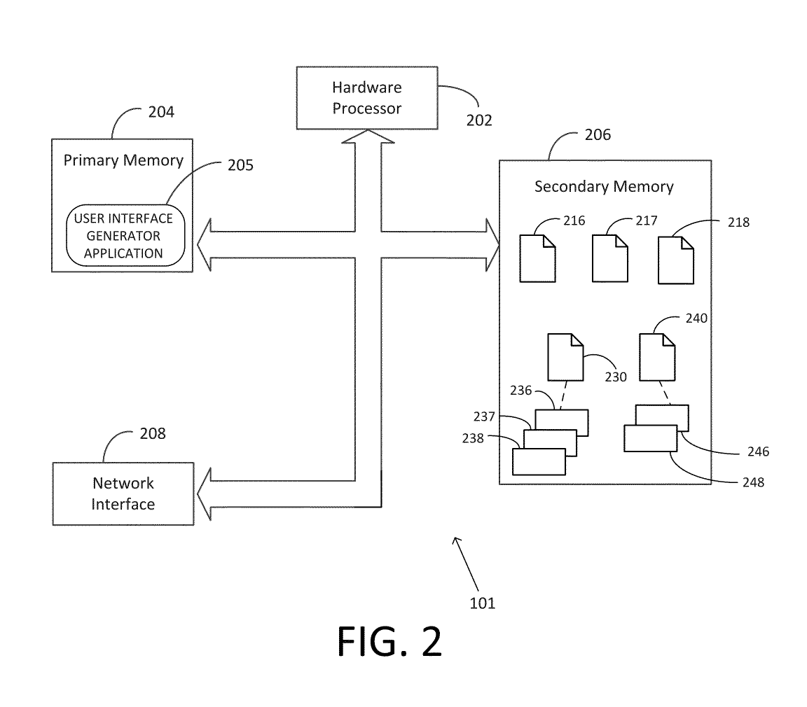

Turning to FIG. 2, a possible implementation of the data server 101 includes a hardware processor 202, a primary memory 204 (e.g., volatile memory, random-access memory), a secondary memory 206 (e.g., non-volatile memory, hard disk memory), and a network interface 208. The data server 101 in general and the hardware processor 202 in particular are able to communicate with the client 120 of FIG. 1 via the network interface 208 over the network 130. The memories 204 and 206 store instructions and data. The hardware processor 202 executes the instructions and uses the data to carry out various procedures including, in some embodiments, the methods described herein. In various embodiments, the instructions stored in the memories 204 or 206 include a user interface generator application 205. In some embodiments, the data server 101 has one or more distributed components, such as a processor cluster for the hardware processor 202 or a distributed data store for the secondary memory 206, which can be communicated with via the network interface 208, a data bus architecture, or other suitable communication channel.

The secondary memory 206 stores one or more electronic documents, for example, electronic documents 216, 217, and 218 and files 230 and 240. One or more of the electronic documents may be implemented as a mark-up language document such as a hypertext markup language (“HTML”) document, an extensible mark-up language (“XML”) document, or an extensible business reporting language (“XBRL”) document. In one embodiment, the data server 101 packages, in response to a request from the client 120, one or more of the electronic documents into an electronic filing package. For example, the data server 101 packages electronic documents 216, 217, and 218 into the electronic filing package 230. In this case, the electronic filing package 230 contains electronic documents 236, 237, and 238 which correspond to the files 216, 217, and 218. In another embodiment, the data server 101 receives a processed package 240 from the publication server 110. For example, the data server 101 receives a processed package 240 that contains processed files 246 and 248.

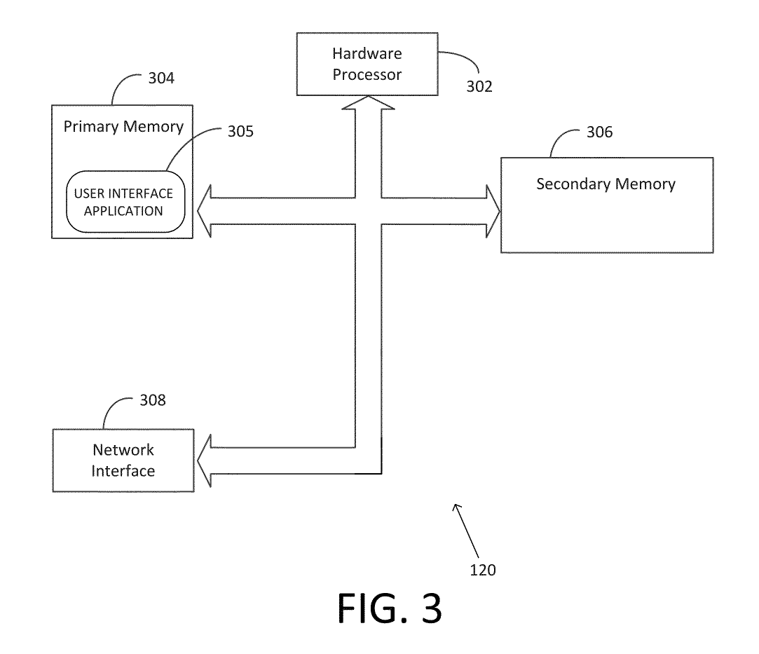

Turning to FIG. 3, a possible implementation of the client 120 includes a hardware processor 302, a primary memory 304 (e.g., volatile memory, random-access memory), a secondary memory 306 (e.g., non-volatile memory, hard disk memory), and a network interface 308. The client 120 in general and the hardware processor 302 in particular are able to communicate with the data server 101 of FIG. 1 via the network interface 308 over the network 130. The memories 304 and 306 store instructions and data. The hardware processor 302 executes the instructions and uses the data to carry out various procedures including, in some embodiments, the methods described herein. In various embodiments, the instructions stored in the memories 304 or 306 include a user interface application 305. The client 120 executes the user interface application 305 and cooperates with the user interface generator application 205 to carry out one or more portions or steps of the methods described herein. In other embodiments, the client 120 executes the user interface application 305 and performs each step of the methods described herein. In this case, the client 120 communicates with the publication server 110 instead of (or in addition to) the data server 101.

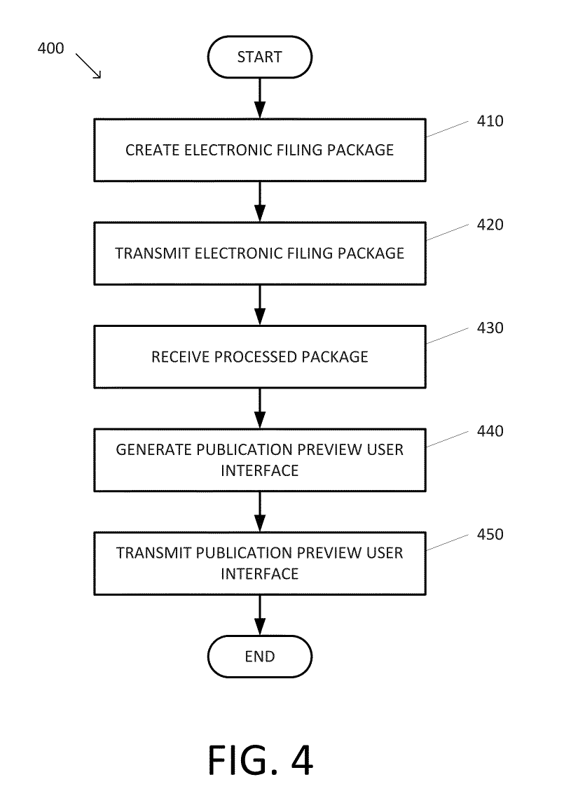

Turning to FIG. 4, a process flow 400 illustrates a method for previewing a publication of electronic documents, according to an embodiment. As an example, a user (not shown) of the client 120 is an employee of a business. The user wishes to prepare and file a Form 8-K, Form 10-Q, supporting exhibits, or other information with the Securities and Exchange Commission. In this example, the Securities and Exchange Commission operates the publication server 110 and sets one or more document validation rules to be applied by the publication server 110 for publication of various filings. The user selects and provides to the data server 101 an indication of which electronic documents should be submitted for a preview of a publication via a user interface (not shown). As one example, the user selects electronic documents 216, 217, and 218 for a preview of a publication. The user also provides an indication to perform a “test filing preview” so that the data server 101 enables a “ReturnCopyFlag” option before transmission to the publication server 110, as described herein.

The data server 101 creates (Step 410) an electronic filing package 230 that includes at least one electronic document. In this case, the electronic filing package 230 includes electronic documents 236, 237, and 238, which are copies of the selected electronic documents 216, 217, and 218. In some scenarios, the data server 101 includes additional information in the electronic filing package 230, such as identifiers of the user, identifiers of the business, or settings for the preview. In some examples, the electronic filing package 230 includes an identifier or flag (e.g., the ReturnCopyFlag) that causes the publication server 110 to process the electronic filing package 230 without causing its publication.

After creation of the electronic filing package 230, the data server 101 transmits (Step 420) the electronic filing package 230 to the publication server 110. In some embodiments, the data server 101 transmits the electronic filing package 230 using an HTML interface provided by the publication server 110.

In some embodiments where the data server 101 is implemented as the front-end server 102 and the filing server 104, the front-end server 102 creates and provides the electronic filing package 230 to the filing server 104. The filing server 104 then transmits the electronic filing package 230 to the publication server 110. In some embodiments, the transmission to the publication server 110 includes an identifier, flag, or a separate message that causes the publication server 110 to process the electronic filing package 230 without actually causing its publication. In other embodiments, the data server 101 transmits the electronic filing package 230 to a predetermined publication server 110 that is dedicated for validation purposes, instead of a server used for publication purposes.

Upon receipt of the electronic filing package 230, the publication server 110 performs document validation processing of the electronic documents within the electronic filing package 230 based on the document validation rules. Based on the document validation processing, the publication server 110 generates the processed package 240 and generates one or more errors, warnings, or informational messages to indicate the success, failure, or related issues with the electronic filing package 230. In some embodiments, the errors are classified as either a major error, minor error, or warning. A major error for an electronic document indicates that the electronic document would be removed from the electronic filing package 230 prior to publication, but the remaining electronic documents of the electronic filing package 230 would still be published. A minor error for an electronic document indicates that the electronic document does not conform to all of the rules or specifications of the publication server 110, but is still allowed to be published. The messages may include an invalid extensible business reporting language message that indicates that a portion of an electronic document contains invalid XBRL content.

The processed package 240 in some embodiments is a filing receipt or “return copy” that has been processed by the publication server 110 based on the document validation rules. The processed package 240 in this case is a single file containing processed files as they would have been processed by the publication server 110 for an actual publication. The format of the return copy is a plain text file format, thus electronic documents that are in an XML, HTML, or XBRL format are generally human-readable, but other embodiments are not limited to the plain text file format. Where multiple processed files are present, the publication server 110 concatenates the files into the single file with suitable file separation delimiters. In the case of non-text or binary files, such as image files, portable document format (PDF) files, or the like, the publication server 110 encodes the non-text files into a plain text file format, for example, by performing a “uuencode” or other suitable binary-to-text encoding process.

The data server 101 receives (Step 430) the processed package 240 from the publication server 110. In some embodiments, the publication server 110 automatically sends the processed package 240 to the data server 101. In other embodiments, the data server 101 sends a request for the processed package 240. In one example, the request is sent by the data server 101 after receipt of an indication of availability of the processed package 240. In another example, the data server waits a predetermined time period (e.g., 5 minutes, 30 minutes, or other suitable period) for the publication server 110 to process the electronic filing package 230. The data server 101 optionally also receives (Step 430) one or more remote process status messages that correspond to the document validation processing. The remote process status messages may include the errors, warnings, or informational messages generated by the publication server 110, as described above.

After receipt of the processed package 240, the data server 101 generates (Step 440) a publication preview user interface based on the processed package 240. When the remote process status messages are also received, the data server 101 generates the publication preview user interface based on both the processed package 240 and the remote process status messages. The publication preview user interface in one example includes one or more hypertext markup language (HTML) documents and may further include one or more processed files extracted from the processed package 240, as described herein. The data server 101 stores the publication preview user interface in the secondary memory 206, preferably with an association to the originally selected electronic documents. The data server 101 optionally transmits the publication preview user interface to the client 120 as a web page for display in a web browser or other suitable software. In other embodiments, the data server 101 compresses the publication preview user interface into a compressed file and transmits the compressed file to the client 120.

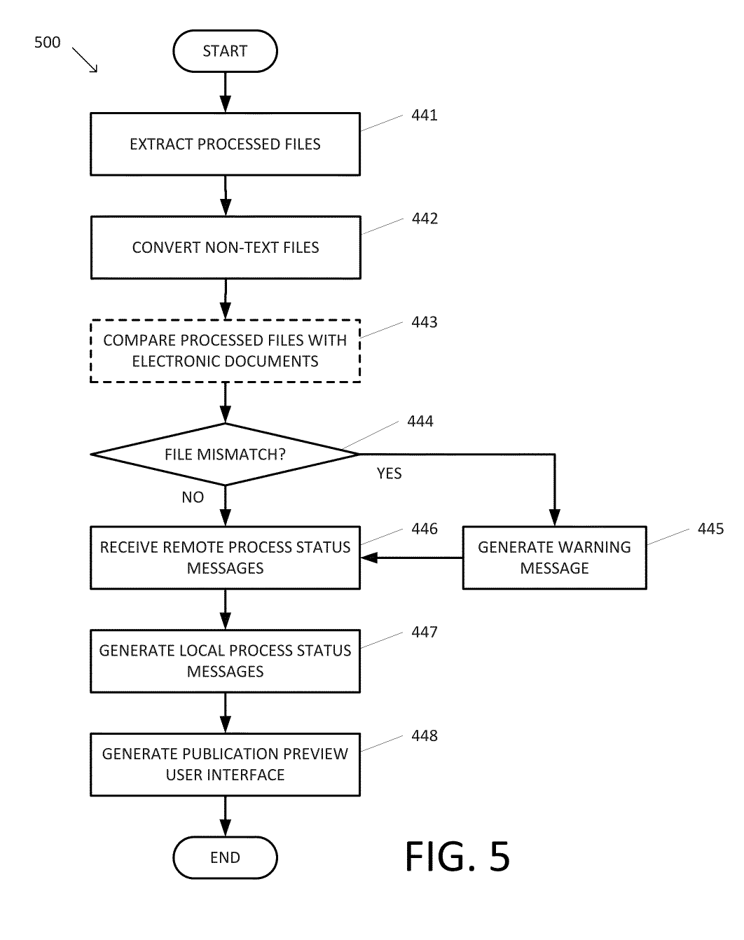

Turning to FIG. 5, a process flow 500 illustrates a method for generating a publication preview user interface, according to an embodiment. After receipt of the processed package 240 (Step 440, FIG. 4), the data server 101 extracts (Step 441) at least one processed file from the processed package, for example, processed files 246 and 248 from processed package 240 as shown in FIG. 2. In some embodiments, the data server 101 separates the return copy based on the file separation delimiters, removing the file separation delimiters to obtain the processed files 246 and 248. Each processed file corresponds to an electronic document of the originally selected electronic documents. For example, the processed files 246 and 248 correspond to electronic documents 216 and 218, respectively. Where appropriate (e.g., the original electronic document is a non-text file), the data server 101 converts (Step 442) the processed files 246 or 248, for example, an encoded text format using a “uudecode” or other suitable process, so that the processed files 246 or 248 have a file format of the corresponding non-text electronic document 216 and 218. This allows the user of the client 120 to view the electronic documents as processed by the publication server 110.

The data server 101 optionally performs (Step 443) a comparison between the originally selected electronic documents 216, 217, and 218 and the processed files 246 and 248. In some scenarios, the comparison provides an indication of whether an originally selected electronic document has been changed after generation of the electronic filing package 230. In this scenario, a user may be alerted when an electronic document used for previewing a publication is not the same electronic document used for a subsequent filing for actual publication. In other scenarios, the comparison provides an indication of whether a file has been omitted from the processed package 240 by the publication server 110, for example, as a result of a major error detected by the publication server 110. The data server 101 determines (Step 444) whether each originally selected electronic document has a respective processed file (e.g., whether there is a file mismatch). In some embodiments, the file mismatch determination is based on the comparison in Step 443. In other embodiments, the data server 101 does not compare the originally selected electronic documents, but simply stores a file count when generating the electronic filing package (e.g., a file count of 3 in the present example) for comparison with the number of processed files extracted from the processed package 240.

In the current example, electronic document 217 does not have a corresponding processed file in the processed package 240 and thus a mismatch is detected. If the data server 101 determines that a file mismatch is detected (YES at Step 444), the data server 101 generates (Step 445) an appropriate warning or error message (e.g., a local process status message). The data server 101 receives (Step 446) one or more remote process status messages that correspond to the document validation processing of the electronic documents performed by the publication server 110. In some embodiments, the remote process status messages include the errors, warnings, or informational messages generated by the publication server 110 as described above.

The data server 101 generates (Step 447) one or more local process status messages for the processed package 240. In some embodiments, the local process status messages are based on the remote process status messages received from the publication server 110. In this case, the local process status messages may provide further clarification of an error, a more precise location or cause of an error, or other suitable information. In some embodiments, the data server 110 applies document validation rules or performs other processing on the processed package 240 (e.g., the comparison in Step 443) to detect errors, warnings, or inconsistencies.

After generation of the local process status messages, the data server 101 generates (448) the publication preview user interface. In some embodiments, the publication preview user interface provides both the local and remote process status messages on a single page or display to simplify a user's viewing and evaluation of the publication preview user interface.

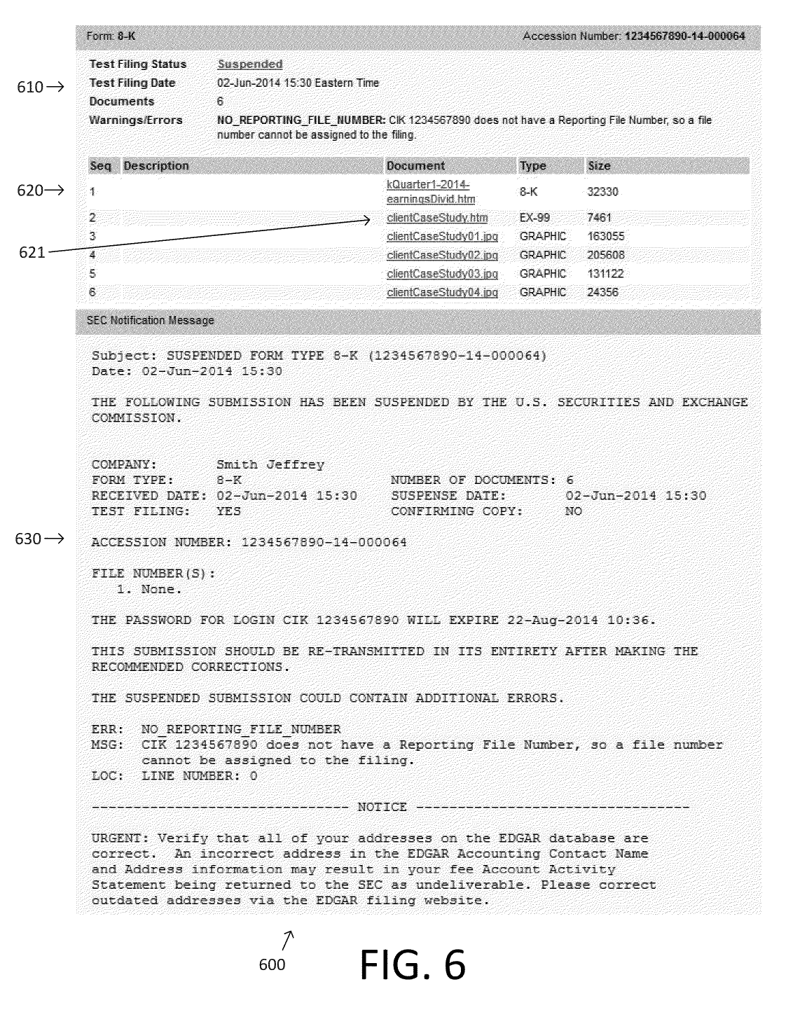

Turning to FIG. 6, one example of a publication preview user interface 600 is shown, according to an embodiment. While the publication preview user interface 600 is implemented as an HTML page, in other embodiments the publication preview user interface 600 is another suitable file type or format, such as a text document or spreadsheet. The publication preview user interface 600 has a status display 610, electronic document listing 620, and notification display 630. In some embodiments, the publication preview user interface 600, or a portion thereof, has a similar appearance to an actual public dissemination website provided by the SEC while also providing visual cues (e.g., adding logos, omitting SEC logos, different color scheme, adding information messages) that the actual publication has not been performed. This promotes user familiarity with SEC publications and simplifies the process of reviewing the filings for accuracy. In some embodiments, the data server 101 uses an HTML template, style template, or other suitable template for generation of the publication preview user interface 600.

The status display 610 generally provides a summary of information related to the processed package 240, such as the filing status (e.g., suspended or accepted), filing date, a number of electronic documents processed by the publication server 110, and an indication of any warnings or errors received from the publication server 110. The electronic document listing 620 provides a listing of electronic documents extracted from the processed package 240 and optionally converted into an appropriate file type. The electronic document listing 620 in some embodiments includes hyperlinks 621 to the extracted and converted files. This allows the user of the client 120 to view the electronic documents as processed by the publication server 110, which may reduce the likelihood of an actual publication with errors, warnings, or incorrect electronic documents. The notification display 630 includes the remote process status messages from the publication server 110. In some embodiments, the notification display 630 also includes the local process status messages.

It can be seen from the foregoing that a method and system for previewing a publication of electronic documents have been described. In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

The apparatus described herein may include a hardware processor, a memory for storing program data to be executed by the hardware processor, a permanent storage such as a disk drive, a communications port for handling communications with external devices, and user interface devices, including a display, touch panel, keys, buttons, etc. When software modules are involved, these software modules may be stored as program instructions or computer readable code executable by the hardware processor on a non-transitory computer-readable media such as magnetic storage media (e.g., magnetic tapes, hard disks, floppy disks), optical recording media (e.g., CD-ROMs, Digital Versatile Discs (DVDs), etc.), and solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the hardware processor.

The disclosed embodiments may be described in terms of functional block components and various processing steps. Such functional blocks may be realized by any number of hardware and/or software components configured to perform the specified functions. For example, the disclosed embodiments may employ various integrated circuit components, e.g., memory elements, processing elements, logic elements, look-up tables, and the like, which may carry out a variety of functions under the control of one or more microprocessors or other control devices. Similarly, where the elements of the disclosed embodiments are implemented using software programming or software elements, the disclosed embodiments may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the disclosed embodiments may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “means”, “device”, “controller”, and “construction” are used broadly and are not limited to mechanical or physical embodiments, but may include software routines in conjunction with processors, etc.

No item or component is essential to the practice of the disclosed embodiments unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the disclosed embodiments (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

The use of any and all examples, or exemplary language (e.g., “such as”) provided herein, is intended merely to better illuminate the disclosed embodiments and does not pose a limitation on the scope of the disclosed embodiments unless otherwise claimed. Numerous modifications and adaptations will be readily apparent to those of ordinary skill in this art.

1. A method for previewing a publication of electronic documents, the method comprising:
creating an electronic filing package that includes at least one electronic document;
transmitting the electronic filing package to a publication server for document validation processing of the at least one electronic document by the publication server based on one or more document validation rules;
transmitting, to the publication server, an indication that the electronic document is to be processed, but not published;
receiving, from the publication server in response to the transmission of the electronic filing package, a filing receipt from the publication server; and
using content from the filing receipt to generate a publication preview user interface for the at least one electronic document,
wherein the user interface has the appearance of a public dissemination of the publication server but includes one or more visual cues indicating that the actual publication has not been performed.

2. The method of claim 1, wherein generating the publication preview user interface comprises:
extracting at least one processed file from the filing receipt, wherein each of the at least one processed file corresponds to an electronic document of the at least one electronic document;
performing a comparison between the at least one electronic document and the at least one processed file;
generating one or more local process status messages based on the comparison; and
generating the publication preview user interface to include the one or more local process status messages.

3. The method of claim 1, wherein generating the publication preview user interface comprises:
extracting at least one processed file from the filing receipt;
determining whether a number of extracted processed files corresponds to a file count for the electronic filing package; and
generating a warning message that indicates a missing processed file if the number of extracted processed files does not correspond to the file count.

4. The method of claim 1, wherein generating the publication preview user interface comprises:
extracting one or more processed files from the filing receipt, wherein each of the one or more processed files corresponds to an electronic document of the at least one electronic document;
converting a non-text file of the one or more processed files into a file format of a corresponding non-text file of the at least one electronic document; and
generating the publication preview user interface to include the converted non-text file.

5. The method of claim 4, wherein converting the non-text file comprises converting the non-text file from an encoded text format into the file format of the corresponding non-text file of the at least one electronic document.

6. The method of claim 1, further comprising receiving, from the publication server, one or more remote process status messages that correspond to the document validation processing of the at least one electronic document;
wherein generating the publication preview user interface comprises generating the publication preview user interface to include the one or more remote process status messages.

7. The method of claim 6, wherein the one or more remote process status messages include an invalid extensible business reporting language message.

8. The method of claim 1, wherein generating the publication preview user interface comprises:
generating one or more hypertext markup language documents as the publication preview user interface; and
providing the one or more hypertext markup language documents to a user via a web browser.

9. The method of claim 1, wherein generating the publication preview user interface comprises:
generating one or more hypertext markup language documents as the publication preview user interface;
compressing the one or more hypertext markup language documents into a compressed file; and
transmitting the compressed file to a client.

10. (canceled)

11. The method of claim 1, wherein generating the publication preview interface comprises generating the publication preview interface using the processed package without using the at least one electronic document.

12. An electronic document publication preview system comprising:
a data server having a hardware processor;
wherein the data server:
creates an electronic filing package that includes at least one electronic document,
transmits the electronic filing package to a publication server for document validation processing of the at least one electronic document by the publication server based on one or more document validation rules,
transmits, to the publication server, an indication that the electronic document is to be processed, but not published,
receives, from the publication server in response to the transmission of the electronic filing package, a filing receipt from the publication server; and
using content from the filing receipt, generates a publication preview user interface for the at least one electronic document,
wherein the user interface has the appearance of a public dissemination of the publication server but includes one or more visual cues indicating that the actual publication has not been performed.

13. The electronic document publication preview system of claim 12, wherein the data server:
extracts at least one processed file from the filing receipt, wherein each of the at least one processed file corresponds to an electronic document of the at least one electronic document,
performs a comparison between the at least one electronic document and the at least one processed file,
generates one or more local process status messages based on the comparison, and
generates the publication preview user interface to include one or more user indications of the one or more remote process status messages and the one or more local process status messages.

14. The electronic document publication preview system of claim 12, wherein the data server:
extracts at least one processed file from the filing receipt;
determines whether a number of extracted processed files corresponds to a file count for the electronic filing package; and
generates a warning message that indicates a missing processed file if the number of extracted processed files does not correspond to the file count.

15. The electronic document publication preview system of claim 12, wherein the data server:
extracts one or more processed files from the filing receipt, wherein each of the one or more processed files corresponds to an electronic document of the at least one electronic document,
converts a non-text file of the one or more processed files from an encoded text format into a file format of a corresponding non-text file of the at least one electronic document, and
generates the publication preview user interface to include the converted non-text file.

16. The electronic document publication preview system of claim 12, wherein the data server:
receives, from the publication server, one or more remote process status messages that correspond to the document validation processing of the at least one electronic document, and
generates the publication preview user interface to include the one or more remote process status messages.

17. (canceled)

18. The electronic document publication preview system of claim 12, wherein the data server generates the publication preview user interface using the processed package without using the at least one electronic document.

19. A non-transitory computer readable storage medium having stored thereon a computer program executable by a hardware processor for performing a method for previewing a publication of electronic documents, the method comprising:
creating an electronic filing package that includes at least one electronic document;
transmitting the electronic filing package to a publication server for document validation processing of the at least one electronic document by the publication server based on one or more document validation rules;
transmitting, to the publication server, an indication that the electronic document is to be processed, but not published;
receiving, from the publication server in response to the transmission of the electronic filing package, a filing receipt from; and
using content from the filing receipt to generate a publication preview user interface for the at least one electronic document,
wherein the user interface has the appearance of a public dissemination of the publication server but includes one or more visual cues indicating that the actual publication has not been performed.

20. The non-transitory computer readable storage medium of claim 19, wherein the step of generating the publication preview user interface comprises:
extracting at least one processed file from the filing receipt, wherein each of the at least one processed file corresponds to an electronic document of the at least one electronic document;
performing a comparison between the at least one electronic document and the at least one processed file;
generating one or more local process status messages based on the comparison; and
generating the publication preview user interface to include one or more user indications of the one or more remote process status messages and the one or more local process status messages.

21. The method of claim 1, wherein the at least one visual cue is selected from the group consisting of an added logo, an omitted logo, and a color scheme.

22. The system of claim 12, wherein the at least one visual cue is selected from the group consisting of an added logo, an omitted logo, and a color scheme.
